(19) United States
(12) Patent Application Publication
(10) Pub. No.: US 2003/0147004 A1
(43) Pub. Date: Aug. 7, 2003

(54) Power supply lock for use with a digital camera having a connector door to slidably and selectively close/open a power supply recess

(76) Inventors: Tongt-Huei Wang, Taipei Hsien (TW); Rosalia Kennedy, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/067,225

(22) Filed: Feb. 7, 2002

(51) Int. Cl. H04N 5/225

(52) U.S. Cl. 348/372

(57) ABSTRACT

A power supply lock has a recess defined in a side face of the connector body and having a clamping plate extending out from a distal edge defining the recess. The clamping plate has a hook formed on a free edge of the clamping plate so as to correspond to one of the tracks of the digital camera to allow the power supply to securely engage with the digital camera.

### BACKGROUND OF THE INVENTION

1. Field of the Invention

The present invention relates to a power supply lock, and more particularly to a power supply lock for use with a digital camera with a connector door so as to selectively close/open a power supply recess. The power supply lock has a clamping plate integrally formed on a side of a connector body of the power supply and a hook formed on a distal edge of the clamping plate so that the clamping plate is able to clamp one side of a pair of tracks formed on a bottom face of the digital camera to allow the power supply to directly supply electricity to the digital camera.

2. Description of Related Art

With reference to FIGS. 3 and 4, a digital camera (3) is provided with a connector door (31) slidably and selectively closing/opening a power supply recess (32). The digital camera (3) has a pair of tracks (33) formed on two opposite sides of the power supply recess (32) so that the connector door (31) is able to slide with respect to the digital camera (3) by means of the tracks (33). After the connector door (31) is opened to expose the power supply recess (32), the user is able to use a power supply dock (4) having a connector (41) formed on top of the power supply dock (4) to correspond to the power supply recess (32) to supply electricity to the digital camera (3). The power supply dock (4) normally has a base (42) formed with the connector (41) so that after the digital camera (3) is connected with the power supply dock (4), the digital camera (3) is able to be seated on top of the power supply dock (4).

Although using this kind of power supply dock (4) does provide electricity to the digital camera (3), the user has to have an adapter (not shown) and the power supply dock (4) simultaneously, which is quite troublesome for the user. Furthermore, the connection between the power supply dock (4) and the digital camera (3) is not firmly secured so that when the power supply dock (4) is in engagement with the digital camera (3), an accidental impact to either the power supply dock (4) or the digital camera (3) may damage both of the devices.

To overcome the shortcomings, the present invention tends to provide an improved power supply lock to mitigate and obviate the aforementioned problems.

### SUMMARY OF THE INVENTION

The primary objective of the present invention is to provide an improved power supply lock, which is able to securely engage with the digital camera so as to prevent the digital camera from damage caused by accidental impact.

In order to accomplish the foregoing objective, the power supply lock has a clamping plate integrally formed on a side of a connector body of the power supply and a hook formed on a distal edge of the clamping plate so that the clamping plate is able to clamp one side of a pair of tracks formed on a bottom face of the digital camera to allow the power supply to securely engage with the digital camera and directly supply electricity to the digital camera.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a power supply lock of the present invention;

FIG. 2 is a bottom view in partial section showing the engagement between the power supply lock and the digital camera;

FIG. 3 is a bottom plan view showing the location of the connector door equipped on a bottom face of the digital camera; and

FIG. 4 is an exploded perspective view showing the digital camera and a conventional power supply dock.

### DETAILED DESCRIPTION OF THE PREFERRED EMBODIMENT

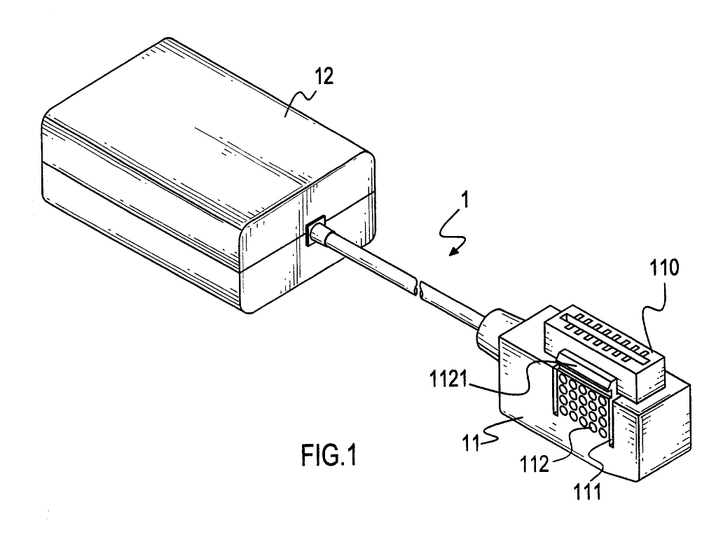

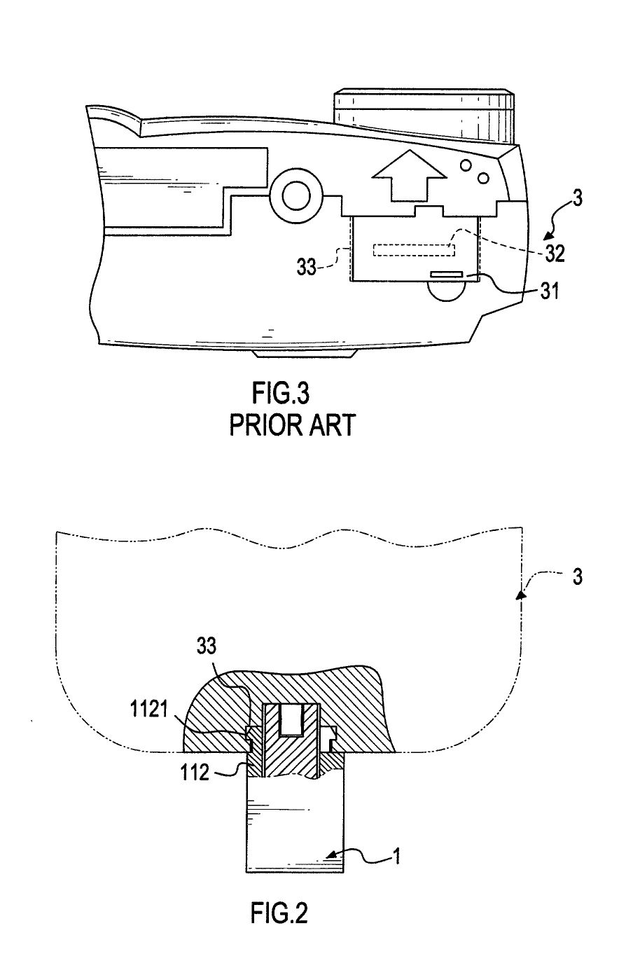

With reference to FIG. 1, a power supply (1) constructed in accordance with the present invention has a connector body (11) and an adapter (12) electrically connected with the connector body (11). The connector body (11) has a connection seat (110) extending out from the connector body (11), a recess (111) defined in a side face of the connector body (11) and a clamping plate (112) integrally extending out from a side face defining the recess (111). The clamping plate (112) has a hook (1121) formed on a distal edge of the clamping plate (112).

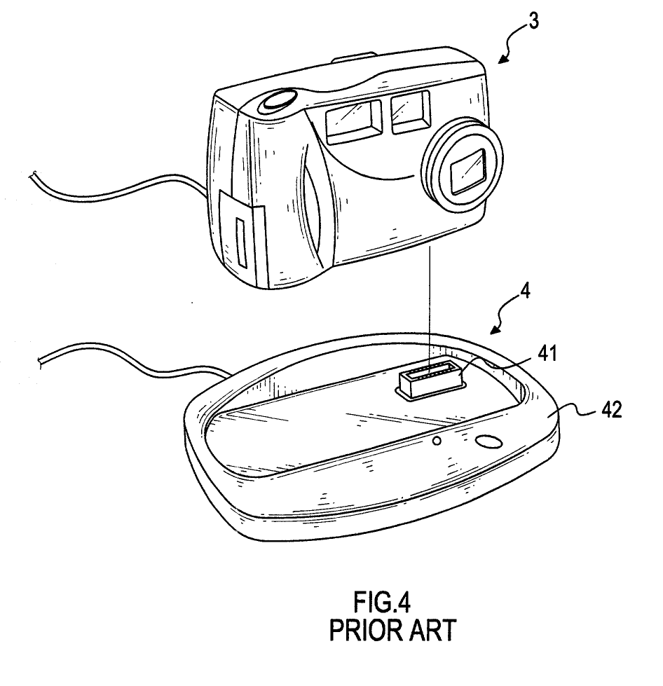

Referring to FIG. 3, the digital camera (3) is provided with a connector door (31) slidably and selectively closing/opening a power supply recess (32). The digital camera (3) has a pair of tracks (33) formed on two opposite sides of the power supply recess (32) so that the connector door (31) is able to slide with respect to the digital camera (3) by means of the tracks (33).

After the connector door (31) is opened to expose the power supply recess (32), the user is able to insert the connection seat (110) of the power supply (1) into the power supply recess (32). When the connection seat (110) is inserted into the power supply recess (32), the clamping plate (112) is deformed and inclined in the recess (111) relative to a bottom face defining the recess (111) until the hook (1121) engages a distal side face of one of the tracks (33). It is noted that when the hook (1121) engages the distal side face of the track (33), the connection seat (110) is fully inserted into the power supply recess (32) so that the power supply (1) is able to supply electricity to the digital camera.

The power supply lock of the invention secures the engagement to the digital camera so as to avoid the damage from an accidental impact to either the power supply or to the digital camera.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. In a power supply having a connector body with a connection seat formed on the connector body, the power supply being adapted to be applicable for use with a digital camera having a connector door slidably and selectively opening a power supply recess along a pair of opposite tracks, wherein a recess is defined in a side face of the connector body and having a clamping plate extending out from a distal edge defining the recess, the clamping plate having a hook formed on a free edge of the clamping plate so as to correspond to one of the tracks to allow the power supply to securely engage with the digital camera.
